(19) United States
(12) Patent Application Publication
(10) Pub. No.: US 2017/0277417 A1
(43) Pub. Date: Sep. 28, 2017

(54) Method for Adjusting Setting and Terminal

(71) Applicants: Le Holdings (Beijing) Co., Ltd., Beijing (CN); Lemobile Information Technology (Beijing) Co., Ltd., Beijing (CN)

(72) Inventor: Jiangjie Tang, Beijing (CN)

(21) Appl. No.: 15/298,490

(22) Filed: Oct. 20, 2016

Related U.S. Application Data
(63) Continuation of application No. PCT/CN2016/096205, filed on Aug. 22, 2016.

(30) Foreign Application Priority Data
Mar. 25, 2016 (CN) 2016101797621

(51) Int. Cl. G06F 3/0484; G06F 3/0488

(52) U.S. Cl. CPC G06F 3/04847; G06F 3/04883; G06F 3/0346

(57) ABSTRACT

Disclosed by the embodiments of the present disclosure are a method for adjusting a setting and terminal. In the method, an operation information of the user at the edge touch area of the terminal is acquired and the setting of the terminal are adjusted according to the operation information of the user at the edge touch area of the terminal. According to the embodiments of the present disclosure, the setting can be directly adjusted, thereby avoiding the problem of cumbersome steps during setting adjustment, reducing the operation cost of the user, improving the operation efficiency, and meanwhile avoiding the problem of operation inconvenience under a particular circumstance.

### CROSS REFERENCE TO RELATED APPLICATIONS

This application is a continuation of International Application No. PCT/CN2016/096205, filed Aug. 22, 2016, and claims priority to Chinese Patent Application No. 2016101797621, filed Mar. 25, 2016, the disclosures of which are hereby incorporated in their entirety by reference.

### TECHNICAL FIELD

The present disclosure relates to the field of communication technologies, and particularly to a method for adjusting a setting and terminal.

### BACKGROUND

The settings in a mobile phone are adjustable, for example, the volume and the screen brightness of the mobile phone. When adjusting the setting, the corresponding setting adjustment interface is needed to be found, and then an adjustment is made in the operating interface to implement the adjustment of the mobile phone's settings.

During the implementation of the present disclosure, the inventor has found there exists the following problem in the prior art: the way to implement a setting adjustment is relatively cumbersome, thus resulting in increase of the operation cost and reduction of the operating efficiency, and leading to the problem of operation inconvenience under a particular circumstance.

### SUMMARY

In view of this, the present disclosure provides a method for adjusting a setting and terminal, for solving the problem in the prior art that the way to implement a setting adjustment is relatively cumbersome, thus resulting in increase of the operation cost and reduction of the operating efficiency, and leading to the problem of operation inconvenience under a specific circumstance.

In order to implement the abovementioned object of the present disclosure, in one aspect, the embodiment of the present disclosure provides a method for adjusting a setting performed by a terminal, and the method includes: acquiring an operation information of a user at an edge touch area of the terminal; and adjusting a setting of the terminal according to the operation information of the user at the edge touch area of the terminal.

According to the abovementioned aspect and any one of the possible implementation manners, an implementation manner is further provided, where adjusting the setting of the terminal according to the operation information of the user at an edge touch area of the terminal includes: detecting whether the operation information is a designated operation for setting adjustment or not; and adjusting the setting of the terminal according to a preset setting adjustment rule and the operation information, if it is detected that the operation information is the designated operation for setting adjustment.

According to the abovementioned aspect and any one of the possible implementation manners, an implementation manner is further provided, where before acquiring the operation information of the user at the edge touch area of the terminal, the method further includes: detecting whether the terminal is in a landscape screen state or a portrait screen state to obtain a detected result; and acquiring the operation information of the user at the edge touch area of the terminal, comprises: acquiring the operation information of the user at an effective area at the edge touch area of the terminal according to the detected result.

According to the abovementioned aspect and any one of the possible implementation manners, an implementation manner is further provided, where when a display state of the screen is the portrait screen state, the method further includes: detecting a current handholding status of the user, the handholding status comprises holding with the right hand and holding with the left hand; if it is detected that the current handholding status of the user is holding with the left hand, the effective area is the edge touch area of the left side of the terminal in the portrait screen state; and if it is detected that the current handholding status of the user is holding with the right hand, the effective area is the edge touch area of the right side of the terminal in portrait screen state.

According to the abovementioned aspect and any one of the possible implementation manners, an implementation manner is further provided, where if the display state of the screen is the landscape screen state, the effective area is an edge touch area in any one of four side surfaces of the terminal.

According to the abovementioned aspect and any one of the possible implementation manners, an implementation manner is further provided, where the operation information of the user at the edge touch area of the terminal includes: a slide operation of the user at the edge touch area of the terminal; or, a click operation of the user at the edge touch area of the terminal; or a press operation of the user at the edge touch area of the terminal.

In the embodiment of the present disclosure, by acquiring operation information of the user at an edge touch area of the terminal, the setting of the terminal is adjusted according to the operation information of the user at the edge touch area of the terminal. Because the setting can be directly adjusted in the embodiment of the present disclosure, the problem of cumbersome steps during setting adjustment can be avoided, the operation cost of the user can be reduced, the operation efficiency can be improved, and meanwhile the problem of operation inconvenience under a particular circumstance can be avoided.

In order to implement the abovementioned object of the present disclosure, in another aspect, the embodiment of the present disclosure provides a terminal including: at least one processor; and a memory communicably connected with the at least one processor for storing instructions executable by the at least one processor, wherein execution of the instructions by the at least one processor causes the at least one processor to: acquire an operation information of a user at an edge touch area of the terminal; and adjust a setting of the terminal according to the operation information of the user at the edge touch area of the terminal.

In order to implement the abovementioned object of the present disclosure, in a further aspect, the embodiment of the present disclosure provides a non-transitory computer-readable storage medium, wherein the non-transitory computer-readable storage medium has stored computer executable instructions, the computer executable instructions are used for: acquiring an operation information of a user at an edge touch area of the terminal; and adjusting a setting of the terminal according to the operation information of the user at the edge touch area of the terminal.

In order to implement the abovementioned object of the present disclosure, in a further aspect, the embodiment of the present disclosure provides a computer program product, comprising a computer program stored in the non-transient computer-readable storage medium, the computer program comprising program instructions that, when executed by a computer, enable the computer to perform the method mentioned by the above aspects.

In the embodiment of the present disclosure, the operation information of the user at an edge touch area of the terminal is acquired by the acquiring module, the settings of the terminal are adjusted by the adjusting module, according to the operation information of the user obtained by the acquiring module at the edge touch area of the terminal. Because the setting can be directly adjusted in the embodiment of the present disclosure, the problem of cumbersome steps during setting adjustment can be avoided, the operation cost of the user can be reduced, the operation efficiency can be improved, and meanwhile the problem of operation inconvenience under a particular circumstance can be avoided.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for adjusting a setting in accordance with some embodiments;

FIG. 2 is a schematic diagram of a structure of a terminal in accordance with some embodiments; and

FIG. 3 is a schematic diagram of a hardware configuration of a terminal for performing the setting adjustment method in accordance with some embodiments.

### DETAILED DESCRIPTION

Preferable embodiments of the present disclosure are hereinafter described in conjunction with the drawings, and it should be understood that the preferable embodiments described herein are only for illustrating and interpreting rather than limiting the present disclosure.

It should be clear that the described embodiments are only part rather than all of the embodiments of the present disclosure. Based on the embodiments of the present disclosure, all other embodiments that can be obtained by those ordinarily skilled in the art without any inventive effort shall fall within the protection scope of the present disclosure.

In the embodiments of the present disclosure, the terms used herein are only for purpose of describing rather than limiting particular embodiments. In the embodiments of the present disclosure and the accompanying claims, the used singular forms “a/an”, “said” and “the” are intended to also include plural forms unless the context clearly dictates otherwise.

It should be understood that although the terms first or second may be used to describe the detecting modules in embodiments of the present disclosure, the detecting modules should not be limited by these terms. The terms are only used to distinguish one detecting module from another detecting module. For example, without departing from the scope of the embodiments of the present disclosure, the first detecting module may also be called the second detecting module. Similarly, the second detecting module may also be called the first detecting module.

Depending on a context, the word “if” as used herein may be interpreted as “at the time of ” or “when ” or “in response to determining” or “in response to detecting”. Similarly, depending on a context, the phrase “if it is determined that” or “if it is detected that (a stated condition or event)” may be interpreted as “when it is determined that” or “in response to determining”; or “when it is detected that (a stated condition or event)” or “in response to detecting that (a stated condition or event)”.

### Embodiment 1

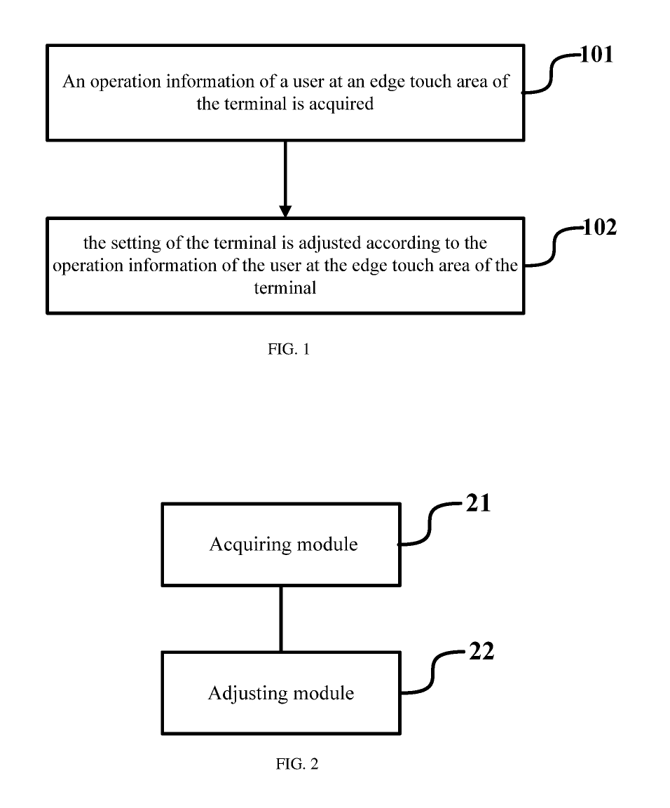

In order to avoid the problems of high operation cost and low operation efficiency during the operation of adjusting a setting and the problem of operation inconvenience caused under a specific circumstance, for example, in a relatively dark environment, if the screen brightness is relatively high, it may cause irritation to a user's eyes, the user may not look straight at the screen to adjust the settings due to dazzling screen light; in an environment with relatively strong light, when the screen brightness is relatively low, the user cannot see clearly the screen and cannot adjust the settings. The embodiment of the present disclosure provides a method for adjusting a setting, specifically as shown in FIG. 1 which is a flow chart of a method for adjusting setting provided by the embodiment of the present disclosure, and the method may include steps 101-102. Where, the method is performed by a terminal. In step 101, an operation information of a user at an edge touch area of the terminal is acquired.

It is to be noted that the terminal involved in the embodiment of the present disclosure may include, but not be limited to, a personal computer (PC), a personal digital assistant (PDA), a wireless handhold device, a tablet computer, a mobile phone, an MP3 player, an MP4 player or the like.

The edge touch is to provide touch input via the edge or border of the terminal to track, click, slide or press a finger on the edge of the terminal, so as to realize the adjustment to the setting of the mobile phone.

The edge touch area of the terminal may be the area where the thumb of a user is able to reach on the side surfaces of the terminal when the user normally holds the terminal, and the side surfaces of the terminal refer to four side surfaces excluding the front surface and back surface.

In the embodiment of the present disclosure, the edge touch area of the terminal may be implemented using physical keys, virtual keys, sensors or screens.

For example, if a terminal uses a curved screen, the edge touch area of the terminal can be implemented using the edge screen of the curved screen. Illustrated by taking a capacitive touch screen as an example, when a user's finger touches the edge touch screen, the capacitance of electric shock will change, so that the frequency of an oscillator connected with the capacitor changes, the touch position can be determined by measuring the frequency change of the oscillator, and then an operation information of a user at the edge touch area of the terminal can be acquired.

Alternatively, for another example, for a terminal without using a curved screen, its edge touch area may be implemented by using physical keys, virtual keys, or a sensor. In the case that there are physical keys for volume adjustment on an edge of the terminal, taking physical keys for volume adjustment in a terminal as an example, when a user's finger presses a physical key for volume adjustment, the terminal will know the user presses an volume up key key or a volume down key, and thus acquiring the operation information of the user at the edge touch area of the terminal. In the case that there are virtual keys with certain settings on the edge of terminal, taking virtual keys of the terminal as an example, and when the virtual keys are capacitive virtual keys, the terminal determines which virtual key is touched by a user through the capacitance of the capacitive virtual key. Specifically, when a user touches a capacitive virtual key, the finger will form a capacitor together with an electrode slice in the capacitive virtual key, and the terminal determines the user touch position by detecting the capacitance change, thereby determining which virtual key is touched by the user, and further can acquire the user operation information at the edge touch area of the terminal. In the case that there are sensors with certain settings on the edge of a terminal, taking sensors on the terminal as an example, and the sensors are pressure sensors, when a user presses a pressure sensor, a semiconductor deformation pressure is formed on the surface of a pressure sensor sheet, and the sheet is pressed to deform so as to generate a piezoelectric impedance effect, so that the impedance change is converted into an electrical signal. After acquiring the electrical signal, the terminal can determine which pressure sensor or which position on the pressure sensor is pressed by the user, so as to determine which pressure sensor for which setting pressed by the user, and then acquire the operation information of a user at the edge touch area of the terminal. In addition, sensors with certain functions on the edge of a terminal may also be light sensors.

Before obtaining the operation information of the user at the edge touch area of the terminal, the method further includes: detecting whether the terminal is in a landscape screen state or a portrait screen state to obtain a detected result.

Specifically, because the handholding manner of the terminal in the landscape screen state is different from that of the terminal in the portrait screen state, which may leads different operation modes, therefore it is required to determine whether the terminal is in the landscape screen state or the portrait screen state at first. Whether the terminal displays in the landscape screen state or the portrait screen state can be determined by the size of height and width of the display image of the screen; when the width of the image is greater than height, it is determined that the terminal is in the landscape screen state, and when the width of the image is smaller than the height, it is determined that the terminal is in the portrait screen state. The determination may also be made by using a gyroscope, which can accurately obtain rotation and deflection actions, gyroscope determines whether the terminal is in the landscape screen state or the portrait screen state by measuring the rotation and deflection actions of the terminal. Of course, the determination may also be made by using a gravity sensor, where a piezoelectric crystal below a gravity block receives a change of the resistance when the gravity block changes its direction due to the gravity; therefore, the direction of the gravity is determined, and whether the terminal is in the landscape screen state or the portrait screen state is determined according to the direction of the gravity.

The detected result is a landscape screen state or a portrait screen state.

Acquiring the operation information of the user at the edge touch area of the terminal includes: acquiring operation information of the user at an effective area at the edge touch area of the terminal.

Specifically, when the terminal is in a landscape screen state or a portrait screen state, the area where the finger of the user is able to normally reach and the operation mode are different. As a result, after the detected result is determined, it is required to further determine an effective area at the edge touch area of the terminal device such that only an operation at the effective area can implement the object of adjusting a setting.

For example, in the case that a curved screen is used in a terminal, when the operation information of a user is obtained by using the edge screen of the curved screen at the edge touch area of the terminal, the effective area of the edge screen is a screen edge area where the thumb of the user is able to click or touch when the user normally holds the terminal. In the case that a physical key for volume adjustment is available on the terminal edge, when the operation information of the user is acquired by using the physical key for volume adjustment at the edge touch area of the terminal, the effective area is the physical key for volume adjustment.

In the case that a virtual key with certain settings is available on the terminal edge, when the operation information of the user is acquired by using the virtual key at the edge touch area of the terminal, the effective area is an area where the virtual key is located. In the case that a sensor with certain settings is available on the terminal edge, when the operation information of the user is acquired by using the sensor at the edge touch area of the terminal, the effective area is an area where the sensor is located.

When the display state of the screen is a portrait screen state, the method further includes: detecting a current handholding status of the user, the handholding status includes holding with the right hand and holding with the left hand.

Specifically, when in the portrait screen state, the user may be holding with the right hand or holding with the left hand. In different handholding statuses, the areas where the user is able to touch during single hand operation are different. For example, when the user's current handholding status is holding with the left hand, the left thumb of the user can be flexibly used and the edge touch area of the left side of the terminal can be touched by the left thumb; when the user's current handholding status is holding with the right hand, the right thumb of the user can be flexibly used and the edge touch area of the right side of the terminal can be reached by the right thumb. Therefore, it is required to detect whether the user is currently holding with the left hand or right hand.

Where, when detecting the current handholding status of the user, the current handholding status of the user may be detected according to the number of the fingers which hold the terminal on both of its right and left edge sides. The purpose of the present disclosure is to determine the current handholding status of the user, therefore, the method for detecting the current handholding status of the user is within the protection scope of the present disclosure.

If it is detected that the current handholding status of the user is holding with the left hand, the effective area is the edge touch area of the left side of the terminal in the portrait screen state; and if it is detected that the current handholding status of the user is holding with the right hand, the effective area is the edge touch area of the right side of the terminal in the portrait screen state.

Specifically, when holding with the left hand and holding with the right hand, the edge touch areas where the user is able to reach are different, thus the effective areas for holding with the left hand and holding with the right hand are different.

If the display state of the screen is a landscape screen state, then the effective area is an edge touch area in any one of the four side surfaces of the terminal.

Specifically, because when the display state of the screen is the landscape screen state, the status in which the user holds the device is relatively special, the user may hold the device with double hands. During this time, the user is able to reach and touch four side surfaces of the device, the four side surfaces of the terminal device may all be effective areas; however, to avoid unnecessary operations from causing operation errors and additional setting adjustment caused by mistaken operations, the effective area may be determined as the edge touch area on one of the four side surfaces according to a preset effective area rule, which one of the side surfaces is chosen as the effective area can be determined depending on an actual requirement.

The operation information of the user at the edge touch area of the terminal includes: a slide operation of the user at the edge touch area of the terminal; or, a click operation of the user at the edge touch area of the terminal; or, a press operation of the user at the edge touch area of the terminal.

Specifically, because the edge touch area may be a side surface of the terminal, a screen edge or certain physical keys, when the edge touch area is a side surface of the terminal and the screen edge, the user may realize the adjustment to the setting by sliding up and down or pressing at the edge touch area. For example, the setting is screen brightness; in the case that the edge touch area is a side surface of the terminal and the screen edge, and the edge touch area is divided into two parts of the area, one part of the area is used to turn up the screen brightness and the other part of the area is used to turn down the screen brightness. If the user wants to turn up the current brightness of the screen, then the user clicks on the area with the turned-up brightness of the screen to achieve the object of turning up the brightness of the screen; if the user wants to turn down the current brightness of the screen, then the user clicks on the area with the turned-down brightness of the screen to achieve the object of turning down the brightness of the screen. The edge touch area which is divided into two parts of the area is also used to adjust and select the adjustment settings, one part of the area is used to turn up or select upward the settings and the other part of the area is used to turn down or select down the settings. For example, the setting is the ringing volume or ring tones, if the user wants to turn up the ringing volume or select another ring tone, then the user clicks on the area for turning up the setting to turn up the ringing volume, or clicks on the part of the area for selecting upward the ring tones to select another ring tone which is in front of the current ring tone in a sequence. If the user wants to turn down the ringing volume or select another ring tone, then the user clicks on the part of the area for turning down the settings to turn down the ringing volume, or clicks on the part of the area for selecting down the ring tones to select another ring tone which is behind the current ring tone in the sequence.

Adjusting the settings further includes switching the settings. Further, the operation information as shown in FIG. 1 also includes the switch of multiple settings in the same setting interface, that is, the setting switch is implemented by clicking, sliding or pressing the edge touch area of the terminal. For example, the currently adjusted setting is screen brightness, and when the volume is needed to be adjusted, the setting switch is implemented by clicking the edge touch area, and the adjustment of the setting is implemented by a combination of slide operation, click operation and press operation. For example, when the setting switch is implemented by a click operation or a press operation, then the settings are adjusted by a slide operation, such as, turning off or on, turning up or down and selecting. It is an object of the embodiment of the present disclosure to realize a setting adjustment by the edge touch; therefore, all of the methods for implementing setting adjustment by the edge touch shall be within the protection scope of the embodiments of the present disclosure.

Where, the setting switch may be implemented by a single edge adjusting area which is used to implement switch of the settings. The setting switch includes up/down switch or left/right switch. The switching is performed in an order of the settings, and the order of the settings may be arranging from top to bottom, from left to right or a combination of from top to bottom and from left to right.

The selection of different settings may also be implemented by clicking an area for a corresponding setting, that is, different settings correspond to different edge touch areas, and switching of a corresponding setting is implemented by clicking a different edge touch area. For example, there are currently three settings: media volume, volume of alarm clock and ringing volume, which respectively correspond to an edge touch area 1, an edge touch area 2 and an edge touch area 3. In this case, the currently adjusted setting is media volume. If a user wants to adjust the volume of the alarm clock or the ringing, then the user clicks on the edge touch area 2 or 3 to switch to the alarm clock volume or the ringing volume, respectively. After switching to the alarm clock volume or the ringing volume, the adjustment of the alarm clock volume or the ringing volume is implemented by clicking at the edge touch area for adjusting the setting corresponding to the alarm clock volume or the ringing volume.

It is an object of the embodiment of the present disclosure to implement setting adjustment by the edge touch, therefore, all the methods for implementing setting adjustment by the edge touch and the method for implementing setting adjustment by using a combination of different edge touch areas shall be within the protection scope of the embodiments of the present disclosure.

In step 102, the setting of the terminal is adjusted according to the operation information of the user at the edge touch area of the terminal.

Specifically, the user may adjust the setting of the terminal by operating on the edge touch area of the terminal.

Adjusting the settings of the terminal according to the operation information of the user at an edge touch area of the terminal specifically includes: detecting whether the operation information is a designated operation for setting adjustment or not; and if it is detected that the operation information is a designated operation for setting adjustment, then adjusting the settings of the terminal according to a preset setting adjustment rule and the operation information.

Specifically, the specified operation for setting adjustment is to determine whether the operation on an effective area by the user can trigger the setting adjustment or not. If the specified operation for the setting adjustment is sliding up or down within the effective area, then it is determined whether the operation is to slide up or down after the operation information is received by the terminal. If the operation information is sliding up or down, the device may determine how to adjust the settings according to the sliding direction, such as turning up or down the ringing volume. During adjusting the setting, the adjustment is performed according to the preset setting adjustment rule. If the preset setting adjustment rule is that the ringing volume will be increased when sliding up along the edge touch area, the ringing volume will be decreased when sliding down along the edge touch area; if the acquired operation information is sliding up, then the ringing volume will be increased; and if the acquired operation information is sliding down, then the ringing volume will be decreased. The preset setting adjustment rule further includes switching the setting. If the preset setting adjustment rule is that the setting will be switched to a front setting in a sequence according to the order when sliding up along the edge touch area, then the setting will be switched to a behind setting in a sequence according to the order when sliding down along the edge touch area. If the acquired operation information is sliding up, then the setting will be switched to a front setting in a sequence according to the order; and if the acquired operation information is sliding down, then the setting will be switched to a behind setting in a sequence according to the order. A specific preset setting adjustment rule may be determined according to actual requirements.

During adjusting the setting, if the operation to be performed is to switch to a front setting in a sequence according to the order, then no switching is done if there is no more front setting in a sequence according to the order; and if the operation to be performed is to switch to a behind setting in a sequence according to the order, then no switching is done if there is no more behind setting in a sequence according to the order.

Where, the specified operation may include press operation, slide operation and click operation, the operation information includes an area which is pressed, clicked or slid along and the preset setting adjustment rule is that the adjustment is made in the part of the areas which are pressed, clicked on and slid along according to the preset setting adjustment manner.

After adjustment is completed, the terminal may be adjusted back to the original setting according to a preset setting adjustment rule and the operation information and may also be adjusted back to the original setting according to a specified operation manner.

In the embodiment of the present disclosure, by acquiring operation information from the user at an edge touch area of the terminal, the setting of the terminal is adjusted according to the operation information of the user at the edge touch area of the terminal. According to the embodiment of the present disclosure, the settings can be directly adjusted, thereby avoiding the problem of cumbersome steps during setting adjustment, reducing the operation cost of the user, improving the operation efficiency, and meanwhile avoiding the problem of operation inconvenience under a particular circumstance.

### Embodiment 2

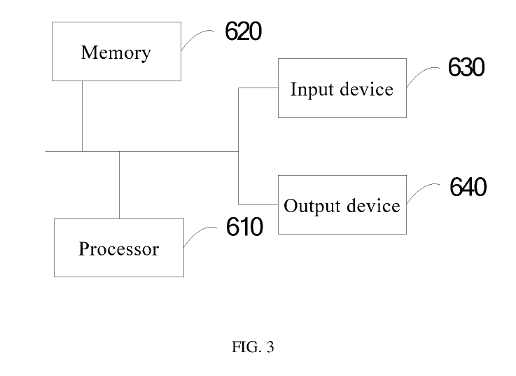

The embodiment of the present disclosure further provides a terminal embodiment which implements various steps and methods in the abovementioned method embodiment. As shown in FIG. 2, which is a setting block diagram of a terminal provided by an embodiment of the present disclosure. The terminal includes an acquiring module 21 and an adjusting module 22.

The acquiring module 21 is used to obtain operation information of a user at an edge touch area of the terminal.

The adjusting module 22 is used to adjust the settings of the terminal according to the operation information of the user at the edge touch areas of the terminal obtained by the acquiring module.

The terminal further includes a first detecting module, which is used to detect whether the operation information indicates a specified operation for setting adjustment or not. The adjusting module is specifically used to adjust the settings of the terminal according to a preset setting adjustment rule and the operation information if it is detected that the operation information indicates the specified operation for setting adjustment.

The terminal further includes a second detecting module, which is used to detect whether the terminal displays in a landscape screen state or a portrait screen state to obtain a detected result before obtaining the operation information of the user at the edge touch area of the terminal. The acquiring module is specifically used to obtain the operation information of a user in an effective area at the edge touch area of the terminal according to the detected result.

Further, the second detecting module is specifically used to detect a current handholding status of the user when the display state of the screen is a portrait screen state, where the handholding status includes holding with the right hand and holding with the left hand. If it is detected that the current handholding status of the user is holding with the left hand, then the effective area is the edge touch area of the left side of the terminal in the portrait screen state; and if it is detected that the current handholding status of the user is holding with the right hand, then the effective area is the edge touch area of the right side of the terminal in the portrait screen state.

If the display state of the screen is a landscape screen state, then the effective area is at an edge touch area on any one of the four side faces of the terminal.

The operation information of the user in the edge touch of the terminal includes: slide operation performed by the user at the edge touch area of the terminal; or click operation performed by the user at the edge touch areas of the terminal; or press operation performed by the user at the edge touch areas of the terminal.

Because respective units according to the embodiment of the present disclosure can perform the method as shown in FIG. 1, for some portions of the embodiment of the present disclosure which are not described in detail, preference may be made to the description related to FIG. 1.

In the embodiment of the present disclosure, the operation information of the user at an edge touch area of the terminal is obtained by the acquiring module, and the settings of the terminal are adjusted by the adjusting module according to the operation information of the user at the edge touch area of the terminal. According to the embodiment of the present disclosure, the settings can be directly adjusted, thereby avoiding the problem of cumbersome steps during setting adjustment, reducing the operation cost of the user, improving the operation efficiency, and meanwhile avoiding the problem of operation inconvenience under a particular circumstance.

### Embodiment 3

The embodiment of the present disclosure provides a non-transitory computer storage medium having computer executable instructions stored thereon, where the computer executable instructions can perform the processing methods in any of the abovementioned method embodiments.

### Embodiment 4

FIG. 3 is a schematic diagram of a hardware configuration of a terminal for performing the setting adjustment method in accordance with some embodiments of the present disclosure. As shown in FIG. 3, the terminal includes:

One or more processors 610 and a memory 620, where one processor 610 is used as an example in FIG. 3. The terminal may further include an input device 630 and an output device 640.

The processor 610, the memory 620, the input device 630 and the output device 640 can be connected via a bus or in another manner. In FIG. 3, the connection via the bus is used as an example.

The memory 620 may be a non-transitory computer-readable storage medium which may be used to store a non-transitory software program, a non-transitory computer executable program and a module. The processor 610 implements the processing methods of the abovementioned method embodiments by executing the non-transitory software program, instructions and modules to perform various functional applications and data processing for an electronic device.

The memory 620 may include a program storage area and a data storage area, where the program storage area may store an operating system and an application required by at least one function; and the data storage area may store data and the like. In addition, the memory 620 may include a high speed random access memory, and may also include a non-volatile memory, such as at least one disk storage device, a flash memory device or other non-volatile solid state memory devices. In some embodiments, the memory 620 optionally includes memories set remotely relative to the processor 610, and these remote memories can be connected to the processing device via the network. An example of the abovementioned network includes, but is not limited to, the Internet, an intranet, LAN, a mobile network or combinations thereof.

The input device 630 may receive input digit or character information, and produce a signal input. The output device 640 may include a display device, such as display screen.

The one or more modules are stored in the memory 620, and when executed by the one or more processors 610, the one or more modules perform the steps of: acquiring an operation information of a user at an edge touch area of the terminal; and adjusting a setting of the terminal according to the operation information of the user at the edge touch area of the terminal.

In a possible implementation manner, adjusting the settings of the terminal according to the operation information of the user at an edge touch area of the terminal, includes: detecting whether the operation information is a designated operation for setting adjustment or not; and adjusting the setting of the terminal according to a preset setting adjustment rule and the operation information, if it is detected that the operation information is the designated operation for setting adjustment.

In a possible implementation manner, before acquiring the operation information of the user at the edge touch area of the terminal, detecting whether the terminal is in a landscape screen state or a portrait screen state to obtain a detected result; and acquiring the operation information of the user at the edge touch area of the terminal, includes: acquiring the operation information of the user at an effective area at the edge touch area of the terminal according to the detected result.

In a possible implementation manner, when a display state of the screen is the portrait screen state, detecting a current handholding status of the user, the handholding status comprises holding with the right hand and holding with the left hand; if it is detected that the current handholding status of the user is holding with the left hand, the effective area is the edge touch area of the left side of the terminal in the portrait screen state; and if it is detected that the current handholding status of the user is holding with the right hand, the effective area is the edge touch area of the right side of the terminal in portrait screen state.

In a possible implementation manner, if the display state of the screen is the landscape screen state, the effective area is an edge touch area in any one of four side surfaces of the terminal.

In a possible implementation manner, the operation information of the user at the edge touch area of the terminal includes: a slide operation of the user at the edge touch area of the terminal; or, a click operation of the user at the edge touch area of the terminal; or a press operation of the user at the edge touch area of the terminal.

The abovementioned products can perform the methods provided by the embodiments of the present disclosure and are provided with relevant function modules for performing the methods and beneficial effects. For the technical details which are not described in detail in the embodiment of the present disclosure, reference may be made to the methods provided by the embodiments of the present disclosure.

The electronic device according to an embodiment of the present disclosure may exist in many forms, including but not limited to:

A mobile communication device: the features of such device have capability of a mobile communication function, and major objectives of providing voice and data communication. Such terminal includes a smart phone (such as, iPhone), a multimedia mobile phone, a feature phone, lower-end phone and the like.

Ultra mobile personal computer equipment: such equipment belongs to the scope of personal computers, which has computing and processing capacities, and generally has a characteristic of mobile internet access. Such terminal includes a PDA, an MID and a UMPC device, such as iPad.

Portable entertainment equipment: such equipment can display and play multimedia contents. Such equipment includes an audio and video player (such as iPod), a handheld game console, an E-book, an intelligent toy and portable vehicle-mounted navigation equipment.

A server: a device which provides computing services. The server is composed of a processor, a hard disk, a memory, a system bus and the like. The server is similar to multipurpose computer architecture, but because the server aims to provide highly reliable services, it has a high requirement for more aspects such as processing power, stability, reliability, security, scalability, manageability.

Other electronic devices with data interaction functions.

The abovementioned device embodiments are illustrative only, and the units which are described as separate parts may be or may not be physically separate, the parts displayed as units may be or may not be physical units, that is, may be located in one place, or may also be distributed to multiple network units. The objects of the solutions of embodiments of the present disclosure can be implemented by selecting part or all of the modules, depending on actual requirements.

From the description of the abovementioned implementations, it is clearly understood by those ordinarily skilled in the art that the embodiments may be implemented by virtue of software in combination with a common hardware platform, and of course, may also be implemented by virtue of hardware. Based on such understandings, the abovementioned technical solutions or the parts contributing to the related technologies may be essentially embodied in the form of software products. The software products may be stored in a computer-readable storage medium, such as an ROM/RAM, a magnetic disk, an optical disk or the like, and include several instructions to instruct a computer device (may be a personal computer, a server or network equipment, etc.) to perform the methods according to various embodiments or some portions thereof.

Finally, it should be noted that the abovementioned embodiments are only used to illustrate but not limit the technical solutions of the present disclosure. Although the present disclosure has been described in detail with reference to the abovementioned embodiments, it should be understood by those ordinarily skilled in the art that modifications may also be made to the technical solutions recited in the abovementioned various embodiments or a part of their technical features may be equivalently substituted without departing from the spirit and scope of the technical solutions of the embodiments of the present disclosure.

What is claimed is:

1. A method for adjusting a setting, performed by a terminal, wherein the said method comprises:
acquiring an operation information of a user at an edge touch area of the terminal; and
adjusting a setting of the terminal according to the operation information of the user at the edge touch area of the terminal.

2. The method according to claim 1, wherein adjusting the setting of the terminal according to the operation information of the user at the edge touch area of the terminal comprises:
detecting whether the operation information is a designated operation for setting adjustment or not; and
adjusting the setting of the terminal according to a preset setting adjustment rule and the operation information, if it is detected that the operation information is the designated operation for setting adjustment.

3. The method according to claim 1, wherein before acquiring the operation information of the user at the edge touch area of the terminal, the method further comprises:
detecting whether the terminal is in a landscape screen state or a portrait screen state to obtain a detected result; and
acquiring the operation information of the user at the edge touch area of the terminal, comprising:
acquiring the operation information of the user at an effective area at the edge touch area of the terminal according to the detected result.

4. The method according to claim 3, wherein when a display state of the screen is the portrait screen state, the method further comprises: detecting a current handholding status of the user, the handholding status comprises holding with a right hand and holding with a left hand;
if it is detected that the current handholding status of the user is holding with the left hand, the effective area is the edge touch area of a left side of the terminal in the portrait screen state; and
if it is detected that the current handholding status of the user is holding with the right hand, the effective area is the edge touch area of a right side of the terminal in the portrait screen state.

5. The method according to claim 3, wherein if the display state of the screen is the landscape screen state, the effective area is an edge touch area in any one of four side surfaces of the terminal.

6. The method according to claim 1, wherein the operation information of the user at the edge touch area of the terminal comprises:
a slide operation of the user at the edge touch area of the terminal; or,
a click operation of the user at the edge touch area of the terminal; or,
a press operation of the user at the edge touch area of the terminal.

7. A terminal, comprising:
at least one processor; and
a memory communicably connected with the at least one processor for storing instructions executable by the at least one processor, wherein execution of the instructions by the at least one processor causes the at least one processor to:
acquire an operation information of a user at an edge touch area of the terminal; and
adjust a setting of the terminal according to the operation information of the user at the edge touch area of the terminal.

8. The terminal according to claim 7, wherein adjusting the setting of the terminal according to the operation information of the user at the edge touch area of the terminal comprises:
detecting whether the operation information is a designated operation for setting adjustment or not; and
adjusting the setting of the terminal according to a preset setting adjustment rule and the operation information, if it is detected that the operation information is the designated operation for setting adjustment.

9. The terminal according to claim 7, wherein execution of the instructions by the at least one processor causes the at least one processor to:
before acquiring the operation information of the user at the edge touch area of the terminal, detect whether the terminal is in a landscape screen state or a portrait screen state to obtain a detected result; and
acquire the operation information of the user at the edge touch area of the terminal, comprising:
acquiring the operation information of the user at an effective area at the edge touch area of the terminal according to the detected result.

10. The terminal according to claim 9, wherein execution of the instructions by the at least one processor causes the at least one processor to:
when a display state of the screen is the portrait screen state, detect a current handholding status of the user, the handholding status comprises holding with a right hand and holding with a left hand;
if it is detected that the current handholding status of the user is holding with the left hand, the effective area is the edge touch area of a left side of the terminal in the portrait screen state; and
if it is detected that the current handholding status of the user is holding with the right hand, the effective area is the edge touch area of a right side of the terminal in the portrait screen state.

11. The terminal according to claim 9, wherein if the display state of the screen is the landscape screen state, the effective area is an edge touch area in any one of four side surfaces of the terminal.

12. The terminal according to claim 7, wherein the operation information of the user at the edge touch area of the terminal comprises:
a slide operation of the user at the edge touch area of the terminal; or,
a click operation of the user at the edge touch area of the terminal; or,
a press operation of the user at the edge touch area of the terminal.

13. A non-transitory computer-readable storage medium, wherein the non-transitory computer-readable storage medium has stored computer executable instructions, the computer executable instructions are used for:
acquiring an operation information of a user at an edge touch area of the terminal; and
adjusting a setting of the terminal according to the operation information of the user at the edge touch area of the terminal.

14. The non-transitory computer-readable storage medium according to claim 13, wherein adjusting the setting of the terminal according to the operation information of the user at the edge touch area of the terminal comprises:
detecting whether the operation information is a designated operation for setting adjustment or not; and
adjusting the setting of the terminal according to a preset setting adjustment rule and the operation information, if it is detected that the operation information is the designated operation for setting adjustment.

15. The non-transitory computer-readable storage medium according to claim 13, wherein the computer executable instructions are used for :
before acquiring the operation information of the user at the edge touch area of the terminal, detecting whether the terminal is in a landscape screen state or a portrait screen state to obtain a detected result; and
acquiring the operation information of the user at the edge touch area of the terminal, comprising:
acquiring the operation information of the user at an effective area at the edge touch area of the terminal according to the detected result.

16. The non-transitory computer-readable storage medium according to claim 15, wherein the computer executable instructions are used for:
when a display state of the screen is the portrait screen state, detecting a current handholding status of the user, the handholding status comprises holding with a right hand and holding with a left hand;
if it is detected that the current handholding status of the user is holding with the left hand, the effective area is the edge touch area of a left side of the terminal in the portrait screen state; and
if it is detected that the current handholding status of the user is holding with the right hand, the effective area is the edge touch area of a right side of the terminal in the portrait screen state.

17. The non-transitory computer-readable storage medium according to claim 15, wherein if the display state of the screen is the landscape screen state, the effective area is an edge touch area in any one of four side surfaces of the terminal.

18. The non-transitory computer-readable storage medium according to claim 13, wherein the operation information of the user at the edge touch area of the terminal comprises:
a slide operation of the user at the edge touch area of the terminal; or,
a click operation of the user at the edge touch area of the terminal; or,
a press operation of the user at the edge touch area of the terminal.
